(19) United States
(12) Patent Application Publication
(10) Pub. No.: US 2024/0069908 A1
(43) Pub. Date: Feb. 29, 2024

(54) PULL REQUEST REVIEW BASED ON EVENT-TRACE STREAMS

(71) Applicant: Hewlett-Packard Development Company, L.P., Spring, TX (US)

(72) Inventors: Mauricio Coutinho Moraes, Porto Alegre (BR); Jhonny Marcos Acordi Mertz, Porto Alegre (BR); Brian Schmitz Tani, Porto Alegre (BR)

(21) Appl. No.: 17/897,759

(22) Filed: Aug. 29, 2022

(51) Int. Cl. G06F 8/71; G06F 8/72; G06F 8/73

(52) U.S. Cl. CPC G06F 8/71; G06F 8/72; G06F 8/73

(57) ABSTRACT

An example device is described for facilitating pull request reviews based on event-trace streams. In various aspects, the device can comprise a processor. In various instances, the device can comprise a non-transitory machine-readable memory that can store machine-readable instructions. In various cases, the processor can execute the machine-readable instructions, which can cause the processor to perform an automated pull request review for a first version of a computing application and a second version of the computing application, based on a first event-trace stream associated with the first version and a second event-trace stream associated with the second version.

### BACKGROUND

When a new version of a computing application is proposed, a pull request review can be performed to determine how the new version of the computing application differs from a current version of the computing application.

### BRIEF DESCRIPTION OF THE DRAWINGS

FIG. 1 illustrates a block diagram of an example, non-limiting apparatus that can facilitate pull request reviews based on event-trace streams in accordance with various examples described herein.

FIG. 2 illustrates a block diagram of an example, non-limiting apparatus including various additional components that can facilitate pull request reviews based on event-trace streams in accordance with various examples described herein.

FIG. 3 illustrates an example, non-limiting block diagram showing how an event-trace stream of a computing application can be generated in accordance with various examples described herein.

FIG. 4 illustrates an example, non-limiting block diagram showing how an event-trace stream of a modified computing application can be generated in accordance with various examples described herein.

FIG. 5 illustrates an example, non-limiting block diagram showing how stream differences can be detected in accordance with various examples described herein.

FIG. 6 illustrates an example, non-limiting block diagram showing how stream difference classifications can be generated in accordance with various examples described herein.

FIG. 7 illustrates a flow diagram of an example, non-limiting computer-implemented method that can facilitate pull request reviews based on event-trace streams in accordance with various examples described herein.

FIGS. 8-9 illustrate flow diagrams of example, non-limiting computer-implemented methods that can facilitate pull request reviews based on event-trace streams in accordance with various examples described herein.

FIGS. 10-11 illustrate block diagrams of example, non-limiting non-transitory machine-readable storage media that can facilitate pull request reviews based on event-trace streams in accordance with various examples described herein.

### DETAILED DESCRIPTION

The following detailed description is merely illustrative and is not intended to limit examples or applications/uses of examples. Furthermore, there is no intention to be bound by any expressed or implied information presented in the preceding Background section or in the Detailed Description section.

When a new version (e.g., newly-edited source code) of a computing application is proposed, a pull request review (e.g., a code review) can be performed to determine, verify, or check how the new version of the computing application differs from a current version of the computing application.

In some cases, a pull request review can be facilitated manually by technicians. That is, technicians can manually comb through source code (e.g., coding scripts) of the current version of the computing application and source code of the new version of the computing application in search of unwanted or mistaken edits. Such manual pull request reviews can be error-prone. Furthermore, such manual pull request reviews can consume excessive amounts of time.

In other cases, a pull request review can be facilitated automatically by a computer. In particular, such computer can be programmed to compare, in pixel-to-pixel fashion, captured images of a graphical user-interface rendered by the current version of the computing application with captured images of a corresponding graphical user-interface rendered by the new version of the computing application. Such automated pull request reviews can consume less time than manual pull request reviews. However, such automated pull request reviews can only catch visually-manifested coding differences between the new version and the current version of the computing application. In other words, any source code differences that do not affect the visually-rendered graphical user-interfaces of the computing application, but which do affect non-visually-rendered behavior of the computing application, cannot be detected by such automated pull request reviews.

Various examples described herein can be considered as being directed to non-limiting techniques for facilitating automated pull request reviews that can capture differences in non-visually-rendered behavior of a computing application. More specifically, various examples described herein can be directed to computer processing devices, computer-implemented methods, apparatuses, or computer program products that can facilitate pull request reviews via event-trace streams. In particular, various examples described herein can automatically subject, via a continuous-integration-continuous-deployment (CI/CD) pipeline, a current version of a computing application to a functional test (e.g., a stress test), thereby yielding a first event-trace stream. Likewise, various examples described herein can automatically subject, via the CI/CD pipeline, a new version of the computing application to the functional test, thereby yielding a second event-trace stream. In various aspects, an event-trace stream can be a chronologically-ordered set or sequence of application events intermingled with execution location traces. Accordingly, the first event-trace stream can be considered as representing the behavior, whether or not visually-manifested in a graphical user-interface, of the current version of the computing application. Similarly, the second event-trace stream can be considered as representing the behavior, whether or not visually-manifested in a graphical user-interface, of the new version of the computing application. In some instances, various examples described herein can compare, via sequential pattern mining, the first event-trace stream to the second event-trace stream, so as to identify any differences between the two event-trace streams (e.g., between the behavior of the current version of the computing application and the behavior of the new version of the computing application). Such differences can be considered as results of performing a pull request review. In this way, a pull request review can be automated to catch non-visually-manifested differences between the current version and the new version, unlike automated pull request reviews that rely on pixel-to-pixel comparisons.

In various aspects, some examples described herein can be considered as a computerized tool (e.g., any suitable combination of computer-executable hardware or machine-readable instructions) that can facilitate pull request reviews based on event-trace streams. In various instances, such computerized tool can comprise an access component, a test component, a difference component, a classification component, or a result component.

In various aspects, there can be a computing application. In various instances, the computing application can be any suitable computer program or any suitable package of computer programs that can perform any suitable functionality for an end-user or for another computing application. In various cases, source code of the computing application can be written in any suitable coding language or with any suitable coding syntax (e.g., Python, C, C++). As a non-limiting example, the computing application can be a web browser application (e.g., can be hypertext markup language (HTML) code that is executable by a web browser).

In various aspects, there can be a modified computing application. In various instances, source code of the modified computing application can be an edited version (e.g., an edited copy) of the source code of the computing application. Accordingly, in various cases, the modified computing application can be considered as a new, proposed, updated, or otherwise altered version of the computing application.

In various aspects, the access component of the computerized tool can electronically receive or otherwise access the computing application or the modified computing application (e.g., can receive or access source code of the computing application or source code of the modified computing application). In some instances, the access component can retrieve the computing application or the modified computing application from any suitable centralized or decentralized data structure (e.g., graph data structure, relational data structure, hybrid data structure), whether remote from or local to the access component. In other instances, the access component can retrieve the computing application or the modified computing application from any other suitable computing devices. In any case, the access component can obtain or access the computing application or the modified computing application, such that other components of the computerized tool can interact with (e.g., read, write, edit, copy, manipulate, execute) the computing application or the modified computing application.

In various aspects, the test component of the computerized tool can electronically store, maintain, control, or otherwise access a CI/CD pipeline. In various instances, the CI/CD pipeline can be any suitable automated application-development environment for building, testing, monitoring, merging, or deploying computing applications. Accordingly, in various cases, the CI/CD pipeline can include any suitable application-development automation tools, such as code compilers, code executors, event listeners, or execution tracers.

In various aspects, the CI/CD pipeline can electronically perform a functional test (e.g., a stress test) on the computing application. In various instances, the functional test can be any suitable controlled input data that can be fed to the computing application, so as to cause the computing application to initiate a corresponding execution sequence/branch. In other words, subjecting the computing application to the functional test can be considered as simulating a particular user-interaction with the computing application, so as to explore how the computing application might respond to such particular user-interaction when deployed. In any case, the CI/CD pipeline can perform the functional test on the computing application. More specifically, in various aspects, the CI/CD pipeline can compile the computing application, can execute the computing application based on such compiling, and can feed to the computing application, during runtime, controlled inputs corresponding to the functional test.

During the functional test, any suitable event listeners or execution tracers of the CI/CD pipeline can continuously, continually, or periodically monitor the computing application, thereby yielding a first event-trace stream associated with the computing application. In particular, in various aspects, an event listener of the CI/CD pipeline can detect, record, track, or otherwise log any suitable application event that can be exhibited by or handled by the computing application during the functional test. As a non-limiting example, an application event can be any suitable HTML document object model (DOM) event, such as a mouse event, a pointer event, a keyboard event, a touchscreen event, an HTML frame/object event, or an HTML form event. Accordingly, event listeners of the CI/CD pipeline can, in various instances, collectively record a first set of application events that are exhibited by or handled by the computing application during the functional test. In various cases, the first set of application events can include any suitable number of application events. In various aspects, the first set of application events can be ordered chronologically (e.g., from earliest to latest, from oldest to youngest).

Furthermore, in various instances, an execution tracer of the CI/CD pipeline can detect, record, track, or otherwise log an execution location trace for each of the first set of application events. In other words, an execution tracer can identify which specific lines of source code of the computing application are executed for or during any given application event exhibited by or handled by the computing application. Accordingly, execution tracers of the CI/CD pipeline can, in various aspects, collectively record a first set of execution location traces that respectively correspond to the first set of application events. In some instances, the first set of application events can be considered as being intermingled with the first set of execution location traces. In various cases, the first set of application events as intermingled with the first set of execution location traces can collectively be considered as the first event-trace stream.

Note that, in various aspects, the first event-trace stream can be considered as representing or conveying how the computing application behaves in response to the functional test. Moreover, note that the first event-trace stream can be considered as representing or conveying visually-rendered behavior of the computing application or non-visually-rendered behavior of the computing application (e.g., some application events might pertain to visually-rendered graphical user-interface elements, whereas other application events might not pertain to visually-rendered graphical user-interface elements; regardless of whether an application event of the computing application pertains to a visually-rendered graphical user-interface element, such application event can be recorded in the first event-trace stream).

Likewise, in various aspects, the CI/CD pipeline can electronically perform the same functional test on the modified computing application. That is, the CI/CD pipeline can compile the modified computing application, can execute the modified computing application based on such compiling, and can feed to the modified computing application, during runtime, controlled inputs corresponding to the functional test. Just as above, subjecting the modified computing application to the functional test can be considered as simulating a particular user-interaction with the modified computing application, so as to explore how the modified computing application might respond to such particular user-interaction when deployed.

In various aspects, during the functional test, the event listeners or execution tracers of the CI/CD pipeline can continuously, continually, or periodically monitor the modified computing application, thereby yielding a second event-trace stream associated with the modified computing application. In particular, the event listeners of the CI/CD pipeline can, in various instances, collectively record a second set of application events that are exhibited by or handled by the modified computing application during the functional test. In various cases, the second set of application events can include any suitable number of application events. Furthermore, in various aspects, the second set of application events can be ordered chronologically. Moreover, in various aspects, the execution tracers of the CI/CD pipeline can collectively record a second set of execution location traces that respectively correspond to the second set of application events (e.g., each of the second set of execution location traces can indicate which particular lines of the source code of the modified computing application were executed for or during a respective application event of the modified computing application). In some instances, the second set of application events can be considered as being intermingled with the second set of execution location traces. In various cases, the second set of application events as intermingled with the second set of execution location traces can collectively be considered as the second event-trace stream.

Note that, just as above, the second event-trace stream can be considered as representing or conveying how the modified computing application behaves in response to the functional test. Moreover, note that the second event-trace stream can be considered as representing or conveying visually-rendered behavior of the modified computing application or non-visually-rendered behavior of the modified computing application (e.g., regardless of whether an application event of the modified computing application pertains to a visually-rendered graphical user-interface element, such application event can be recorded in the second event-trace stream).

In various aspects, the difference component of the computerized tool can identify a set of differences between the first event-trace stream and the second event-trace, based on sequential pattern mining. In particular, the difference component can electronically store, maintain, control, or otherwise access a sequential pattern miner. In various instances, the sequential pattern miner can be any suitable machine-readable instructions that, upon execution, can perform any suitable sequential pattern mining technique on inputted sequences. Non-limiting examples of such sequential pattern mining technique can include a generalized sequential pattern (GSP) algorithm, a sequential pattern discovery using equivalence classes (SPADE) algorithm, a frequent patten-projected sequential pattern mining (FreeSpan) algorithm, a prefix-projected sequential pattern mining (PrefixSpan) algorithm, a mining association pattern among preferred residues (MAPres) algorithm, or a sequence to pattern generation (Seq2Pat) algorithm.

In any case, the first event-trace stream can be considered as a sequence of application events exhibited or handled by the computing application, with each application event having a respective ordered position within the sequence and being tagged with a corresponding execution location trace of the computing application. Likewise, the second event-trace stream can be considered as a sequence of application events exhibited or handled by the modified computing application, with each application event having a respective ordered position within the sequence and being tagged with a corresponding execution location trace of the modified computing application. Accordingly, because the first event-trace stream and the second event-trace stream can both be considered as sequences, they can be fed as input to the sequential pattern miner, and the sequential pattern miner can identify as output any suitable number of differences (e.g., mismatches, discrepancies, inconsistencies) between the first event-trace stream and the second event-trace stream. As some non-limiting examples, the sequential pattern miner can identify or detect as a difference: an application event in the first event-trace stream that is not present in the second event-trace stream; an application event in the second event-trace stream that is not present in the first event-trace stream; an application event at a given ordered position in the first event-trace stream that does not match a respective application event at the given ordered position in the second event-trace stream; or an application event at a given ordered position in the first event-trace stream whose execution location trace does not match that of a respective application event at the given ordered position in the second event-trace stream. In various cases, the differences identified/detected by the sequential pattern miner can be referred to as the set of differences between the first event-trace stream and the second event-trace stream.

In various aspects, the classification component of the computerized tool can electronically classify each of the set of differences between the first event-trace stream and the second event-trace stream as being expected or as being unexpected. In particular, the classification component can, in various instances, receive, retrieve, obtain, or otherwise access a set of expected differences associated with the modified computing application or with the functional test. In various cases, the set of expected differences can be manually-crafted by technicians that are developing the modified computing application. In various other cases, the set of expected differences can be derived from or otherwise based on historical differences that have been observed in response to similar computing application modifications that have been performed previously. In any case, the set of expected differences can be considered as representing any suitable number of differences between the first event-trace stream and the second event-trace stream that are expected or otherwise intended to occur (e.g., that are expected or intended to be caused by the edits made to the modified computing application). Accordingly, the classification component can classify each of the set of differences by comparing with the set of expected differences. For example, if a given difference in the set of differences is within (e.g., is present in) the set of expected differences, then the classification component can classify that given difference as expected. In contrast, if a given difference in the set of differences is not within (e.g., is not present in) the set of expected differences, then the classification component can classify that given difference as unexpected. In this way, the classification component can classify each of the set of differences as either being an expected difference or an unexpected difference.

In various aspects, the set of differences between the first event-trace stream and the second event-trace stream, as classified by the classification component, can be considered as results of performing a pull request review between the computing application and the modified version of the computing application. Accordingly, the result component of the computerized tool can electronically initiate any suitable electronic action based on the set of differences (e.g., based on such pull request review results). As a non-limiting example, the result component can transmit the set of differences (with or without the corresponding classifications) to any suitable computing device. In various cases, such transmission can notify a technician of the results of the pull request review between the computing application and the modified version of the computing application. As another non-limiting example, the result component can render the set of differences (with or without the corresponding classifications) on any suitable electronic display, screen, or monitor. In various cases, such rendition can allow a technician to visually inspect the results of the pull request review between the computing application and the modified version of the computing application. As yet another non-limiting example, the result component can prohibit or generate an electronic warning recommending against deployment of the modified version of the computing application, if any of the set of differences is classified as unexpected. As still another non-limiting example, the result component can prohibit or generate an electronic warning recommending against deployment of the modified version of the computing application, if any of the set of expected differences is absent from the set of differences.

Accordingly, various examples described herein can be considered as a computerized tool that can facilitate pull request reviews based on event-trace streams. Unlike automated pull request reviews that rely on pixel-to-pixel comparisons, automated pull request reviews that rely on event-trace streams as described herein can capture or otherwise detect non-visually-manifested differences between two different versions of a computing application.

Various examples described herein can be employed to use computerized hardware or machine-readable instructions to perform functionalities that are highly technical in nature (e.g., to facilitate pull request reviews based on event-trace streams), that are not abstract and that cannot be performed as a set of mental acts by a human. Further, some of the processes performed can be performed by a specialized computer (e.g., CI/CD pipeline, code compilers, code executors, event listeners, execution tracers) for carrying out defined tasks related to pull request reviews. For example, such defined tasks can include: performing an automated pull request review for a first version of a computing application and a second version of the computing application, based on a first event-trace stream associated with the first version and a second event-trace stream associated with the second version. In various instances, the first event-trace stream can comprise a first set of application events exhibited by the first version and intermingled with a first set of execution location traces of the first version, and the second event-trace stream can comprise a second set of application events exhibited by the second version and intermingled with a second set of execution location traces of the second version. In various cases, such defined tasks can further include: generating the first event-trace stream and the second event-trace stream, based on a functional test to be applied to the first version and to the second version via a continuous-integration-continuous-deployment pipeline. Furthermore, in various aspects, the automated pull request review can be based on a sequential pattern mining comparison between the first event-trace stream and the second event-trace stream.

Such defined tasks are not performed manually by humans. Indeed, neither the human mind nor a human with pen and paper can: electronically access two different versions of a computing application; electronically perform, via a CI/CD pipeline comprising, a functional test on such two different versions of the computing application, thereby yielding two different event-trace streams; and electronically execute a sequential pattern mining algorithm on the two different event-trace streams. Instead, various examples described herein are inherently and inextricably tied to computer technology and cannot be implemented outside of a computing environment. Indeed, a CI/CD pipeline is an inherently computerized application-development automation tool that can comprise code compilers, code executors, event listeners, or execution tracers, none of which can be implemented by humans without computers. Accordingly, a computerized tool that can execute a CI/CD pipeline to generate two different event-trace streams associated with two different versions of a computing application and that can compare the two different event-trace streams via sequential pattern mining is likewise inherently computerized and cannot be implemented in any sensible, practical, or reasonable way without computers.

Moreover, various examples described herein can integrate into a practical application various teachings relating to pull request reviews via event-trace streams. As explained above, various automated pull request review techniques rely upon pixel-to-pixel comparisons between images of first graphical user-interfaces rendered by one version of a computing application and images of second graphical user-interfaces rendered by another version of the computing application. Such pixel-to-pixel comparison techniques are unable to detect differences, changes, or edits between the two versions of the computing application that are not reflected or manifested in a visually-rendered graphical user-interface of the computing application. In contrast, various examples described herein can include automated pull request review techniques that implement event-trace stream comparison. As explained herein, an event-trace stream of a computing application can capture, represent, or otherwise convey behavior, irrespective of whether that behavior is reflected or manifested in a visually-rendered graphical user-interface. Accordingly, various examples described herein can detect differences, changes, or edits between two different versions of the computing application, even if such differences, changes, or edits are not reflected or manifested in a visually-rendered graphical user-interface of the computing application. In other words, various examples described herein can detect coding edits that would otherwise slip past (e.g., which would otherwise go undetected by) pixel-to-pixel comparison techniques. Accordingly, various examples described herein constitute a useful and practical application of computers.

Furthermore, various examples described herein can control real-world tangible devices based on the disclosed teachings. For example, various examples described herein can electronically access two different versions (e.g., two different code bases) of a real-world computing application, can electronically leverage a real-world CI/CD pipeline (e.g., having real-world compilers, real-world executors, real-world listeners, real-world tracers) to generate event-trace streams of such two different versions of the real-world computing application, and can electronically perform a pull request review by comparing the event-trace streams via sequential pattern mining.

It should be appreciated that the herein figures and description provide non-limiting examples and are not necessarily drawn to scale.

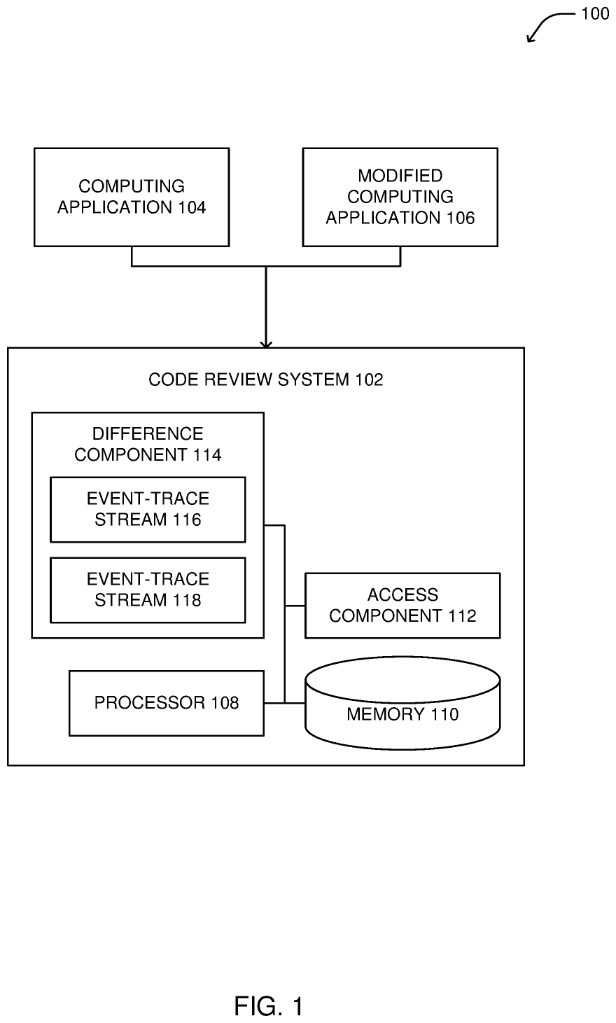

FIG. 1 illustrates a block diagram of an example, non-limiting apparatus 100 that can facilitate pull request reviews based on event-trace streams in accordance with various examples described herein. As shown, a code review system 102 can be electronically integrated, via any suitable wired or wireless electronic connections, with a computing application 104 or with a modified computing application 106.

In various aspects, the computing application 104 can be any suitable computer program, or any suitable suite of computer programs, that can facilitate any suitable functionality for an end-user of the computing application 104 or for another computing application that can call, invoke, or otherwise depend upon the computing application 104. In various instances, the computing application 104 (e.g., source code of the computing application 104) can be written in any suitable coding language or coding syntax. As some non-limiting examples, the computing application 104 can be written in C, C++, C #, Python, Java, JavaScript, Visual Basic, Structured Query Language (SQL), Assembly Language, Personal Home Page Hypertext Preprocessor (PHP), or HTML. In various cases, the computing application 104 can be executable by any suitable computing device. As a non-limiting example, the computing application 104 can be HTML code that is executable by a web browser.

In various aspects, the modified computing application 106 can be any suitable modified, changed, adjusted, revised, updated, or otherwise edited version of the computing application 104. In other words, the modified computing application 106 can be generated by incorporating any suitable edits (e.g., insertions, deletions) into a copy of the source code of the computing application 104. In still other words, the modified computing application 106 can be considered as a different (e.g., changed) version of the computing application 104. As a non-limiting example, the computing application 104 can be considered as a currently-released version of itself, and the modified computing application 106 can be considered as a proposed replacement (e.g., a proposed new release) of the computing application 104.

In various examples, as described herein, the code review system 102 can automatically perform a pull request review between the computing application 104 and the modified computing application 106.

In various aspects, the code review system 102 can comprise a processor 108 (e.g., computer processing unit, microprocessor) and a non-transitory computer-readable memory 110 that can be operably or operatively or communicatively connected or coupled to the processor 108. Non-limiting examples of the non-transitory computer-readable memory 110 can include a scratchpad memory, a random access memory (“RAM”), a cache memory, a non-volatile random-access memory (“NVRAM”), or any suitable combination thereof. The non-transitory computer-readable memory 110 can store machine-readable instructions which, upon execution by the processor 108, can cause the processor 108 or other components of the code review system 102 (e.g., access component 112, difference component 114) to perform any suitable number of acts. In various examples, the non-transitory computer-readable memory 110 can store computer-executable components (e.g., access component 112, difference component 114), and the processor 108 can execute the computer-executable components.

In various aspects, the code review system 102 can comprise an access component 112. In various instances, the access component 112 can electronically receive or otherwise electronically access the computing application 104 or the modified computing application 106. For example, the access component 112 can electronically retrieve the computing application 104 or the modified computing application 106 from any suitable centralized or decentralized data structure (not shown) that stores or otherwise maintains the computing application 104 or the modified computing application 106. As another example, the access component 112 can electronically retrieve the computing application 104 or the modified computing application 106 from any suitable computing devices associated with the computing application 104 or with the modified computing application 106. In any case, the access component 112 can electronically obtain or access the computing application 104 or the modified computing application 106, such that other components of the code review system 102 can electronically interact with the computing application 104 or with the modified computing application 106.

In various aspects, the code review system 102 can comprise a difference component 114. In various instances, the difference component 114 can, as described herein, electronically perform an automated pull request review for the computing application 104 and for the modified computing application 106, by comparing an event-trace stream 116 to an event-trace stream 118.

In various cases, the event-trace stream 116 can comprise a chronologically-ordered set of application events exhibited by the computing application 104 in response to a functional test. In various aspects, an application event of the computing application 104 can be any suitable HTML DOM event performed by or handled by the computing application 104, such as a mouse event pertaining to a particular data object, a pointer event pertaining to a particular data object, a keyboard event pertaining to a particular data object, a touchscreen event pertaining to a particular data object, an HTML frame event pertaining to a particular data object, or an HTML form event pertaining to a particular data object. In various instances, the event-trace stream 116 can further comprise a set of execution location traces respectively corresponding to the chronologically-ordered set of application events exhibited by the computing application 104. In various cases, an execution location trace of the computing application 104 can be any suitable electronic data indicating which specific lines of source code of the computing application 104 were executed for or during a respectively corresponding application event of the computing application 104. Accordingly, the event-trace stream 116 can be considered as representing, indicating, or otherwise conveying how the computing application 104 responded to the functional test. In some cases, an application event might pertain to or otherwise be manifested in a visually-rendered graphical user-interface of the computing application 104. In other cases, an application event might not pertain to or might not otherwise be manifested in a visually-rendered graphical user-interface of the computing application 104. Accordingly, the event-trace stream 116 can be considered as holistically representing the behavior of the computing application 104, regardless of whether such behavior is visually-manifested in a graphical user-interface or is not visually-manifested in a graphical user-interface.

Similarly, in various aspects, the event-trace stream 118 can comprise a chronologically-ordered set of application events exhibited by the modified computing application 106 in response to the same functional test. In various instances, an application event of the modified computing application 106 can be any suitable HTML DOM event performed by or handled by the modified computing application 106 (e.g., a mouse event, a pointer event, a keyboard event, a touchscreen event, an HTML frame event, an HTML form event). In various cases, the event-trace stream 118 can further comprise a set of execution location traces respectively corresponding to the chronologically-ordered set of application events exhibited by the modified computing application 106. In various aspects, an execution location trace of the modified computing application 106 can be any suitable electronic data indicating which specific lines of source code of the modified computing application 106 were executed for or during a respectively corresponding application event of the modified computing application 106. Accordingly, the event-trace stream 118 can be considered as representing, indicating, or otherwise conveying how the modified computing application 106 responded to the functional test. Just as above, an application event might, in some cases, be manifested in a visually-rendered graphical user-interface of the modified computing application 106, or might, in other cases, not be manifested in a visually-rendered graphical user-interface of the modified computing application 106. Accordingly, the event-trace stream 118 can be considered as holistically representing the behavior of the modified computing application 106, irrespective of whether such behavior is visually-manifested in a graphical user-interface or is not visually-manifested in a graphical user-interface.

In various aspects, the difference component 114 can compare the event-trace stream 116 to the event-trace stream 118 (e.g., can compare the behavior of the computing application 104 to the behavior of the modified computing application 106) via sequential pattern mining. In particular, the event-trace stream 116 can be considered as a sequence of application events of the computing application 104, where each of such application events has as attributes an ordered position within the sequence and an execution location trace. Likewise, the event-trace stream 118 can be considered as a sequence of application events of the modified computing application 106, where each of such application events has as attributes an ordered position within the sequence and an execution location trace. Accordingly, since both the event-trace stream 116 and the event-trace stream 118 can be considered as sequences, the difference component 114 can apply any suitable sequential pattern mining technique to the event-trace stream 116 and to the event-trace stream 118, so as to analyze such sequences (e.g., to identify common subsequences between the event-trace stream 116 and the event-trace stream 118, to identify common super-sequences between the event-trace stream 116 and the event-trace stream 118, to identify sequential discrepancies between the event-trace stream 116 and the event-trace stream 118).

More specifically, in various instances, the difference component 114 can identify, via any suitable sequential pattern mining technique (e.g., GSP, SPADE), a set of stream differences between the event-trace stream 116 and the event-trace stream 118. As a non-limiting example, such set of stream differences can indicate which, if any, application events are present in the event-trace stream 116 but absent from the event-trace stream 118. As another non-limiting example, such set of stream differences can indicate which, if any, application events are present in the event-trace stream 118 but absent from the event-trace stream 116. As still another non-limiting example, such set of stream differences can indicate which, if any, application events between the event-trace stream 116 and the event-trace stream 118 have the same ordered position as each other but have different execution location traces as each other.

In any case, the set of stream differences can be considered as being results of a pull request review of the computing application 104 and of the modified computing application 106.

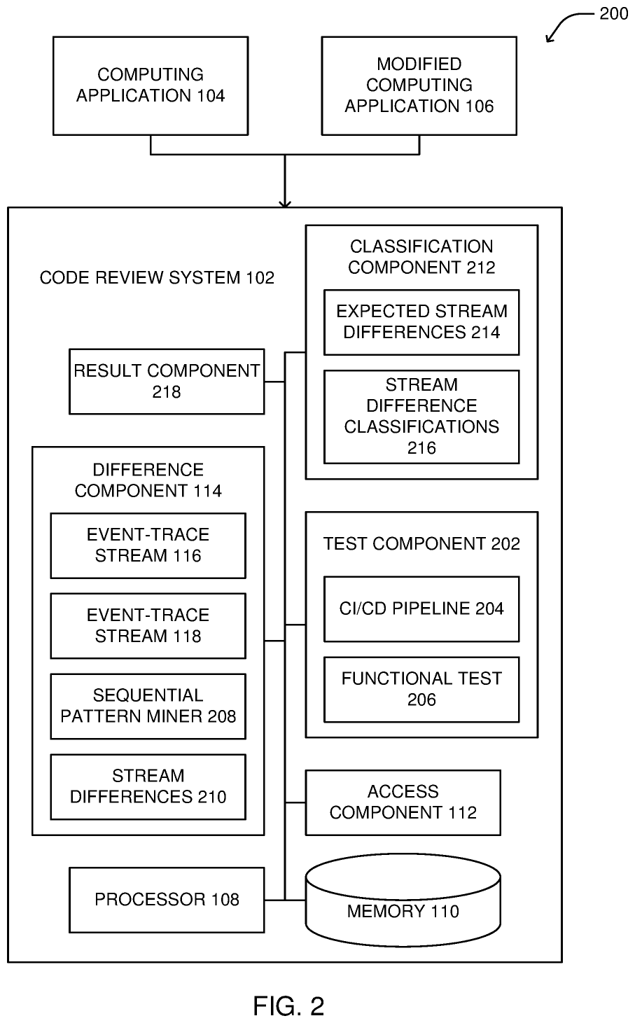

FIG. 2 illustrates a block diagram of an example, non-limiting apparatus 200 including various additional components that can facilitate pull request reviews based on event-trace streams in accordance with various examples described herein.

In various examples, as shown, the code review system 102 can comprise a test component 202. In various aspects, the test component 202 can electronically store, electronically maintain, electronically control, or otherwise electronically access a continuous-integration-continuous deployment pipeline 204 (hereafter “CI/CD pipeline 204”). In various instances, the CI/CD pipeline 204 can be any suitable collection of application-development automation tools for building, testing, merging, or deploying computing applications. In various cases, the CI/CD pipeline 204 can comprise any suitable number of any suitable types of automated code compilers, which can compile computing applications that are inputted into the CI/CD pipeline 204. In various aspects, the CI/CD pipeline 204 can comprise any suitable number of any suitable types of automated code executors, which can execute computing applications that are compiled by the CI/CD pipeline 204. In various instances, the CI/CD pipeline 204 can comprise any suitable number of any suitable types of automated event listeners, which can monitor, track, or otherwise detect application events exhibited during runtime by computing applications that are executed by the CI/CD pipeline 204. In various cases, the CI/CD pipeline 204 can comprise any suitable number of any suitable types of automated execution tracers, which can monitor, track, or otherwise detect, for any given application event, which specific lines of code of a computing application were executed for or during that given application event.

In various aspects, the test component 202 can electronically store, electronically maintain, electronically retrieve, or otherwise electronically access a functional test 206. In various instances, the functional test 206 can be any suitable specification of a controlled input which the CI/CD pipeline 204 can feed, before or during runtime, to a computing application that is executed by the CI/CD pipeline 204. In various cases, such controlled input can have any suitable format, size, or dimensionality. As some non-limiting examples, such controlled input can be any suitable number of scalars, any suitable number of vectors, any suitable number of matrices, any suitable number of tensors, any suitable number of character strings, or any suitable combination thereof. In various aspects, the functional test 206 can be considered as representing simulated user-interaction with a computing application executed by the CI/CD pipeline 204, to explore how the computing application would respond to such user-interaction upon deployment.

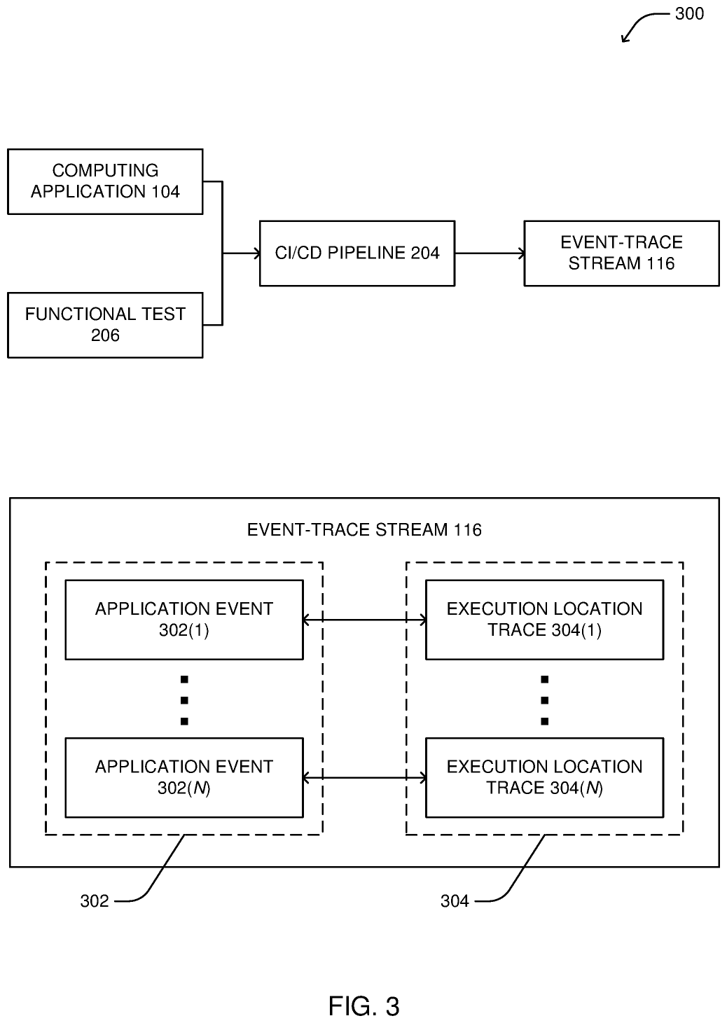

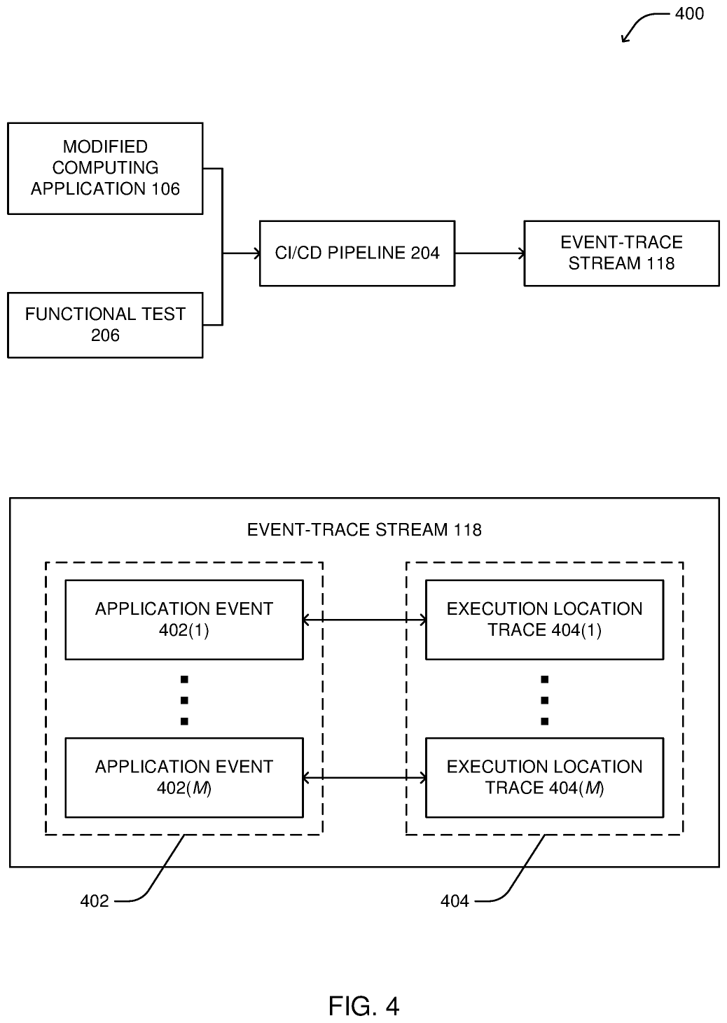

In various aspects, the CI/CD pipeline 204 can apply the functional test 206 to the computing application 104, thereby yielding the event-trace stream 116. Likewise, in various instances, the CI/CD pipeline 204 can apply the functional test 206 to the modified computing application 106, thereby yielding the event-trace stream 118. Various aspects are described with respect to FIGS. 3-4.

FIG. 3 illustrates an example, non-limiting block diagram 300 showing how the event-trace stream 116 of the computing application 104 can be generated in accordance with various examples described herein.

In various aspects, as shown, the test component 202 can execute the CI/CD pipeline 204 on the computing application 104. In particular, the CI/CD pipeline 204 can subject or expose the computing application 104 to the functional test 206. Indeed, in various instances, any suitable code compilers of the CI/CD pipeline 204 can compile the computing application 104 (e.g., can compile source code of the computing application 104). Based on such compilation, in various cases, any suitable code executors of the CI/CD pipeline 204 can execute the computing application 104. During runtime of the computing application 104, any suitable code executors of the CI/CD pipeline 204 can feed to the computing application 104 any suitable controlled inputs as specified by the functional test 206. In various aspects, as the computing application 104 is undergoing the functional test 206, any suitable event listeners of the CI/CD pipeline 204 can monitor the computing application 104, so as to record, log, capture, or otherwise detect any application events exhibited by the computing application 104 in response to the functional test 206. Furthermore, in various instances, any suitable execution tracers of the CI/CD pipeline 204 can monitor the computing application 104, so as to record, log, capture, or otherwise identify an execution location trace for each application event exhibited by the computing application 104 in response to the functional test 206. In various cases, such monitoring by the event listeners or execution tracers of the CI/CD pipeline 204 can yield the event-trace stream 116.

In various aspects, as shown, the event-trace stream 116 can comprise a set of application events 302. In various instances, the set of application events 302 can include n events for any suitable positive integer n: an application event 302(1) to an application event 302(n). In various cases, the set of application events 302 can be considered as indicating, in chronological order, the application events exhibited by the computing application 104 and recorded by the event listeners of the CI/CD pipeline 204 (e.g., can be considered as indicating the application events which the computing application 104 exhibits in response to the functional test 206). For example, the application event 302(1) can be considered as a first application event that the computing application 104 exhibited in response to or otherwise during the functional test 206, and the application event 302(n) can be considered as an n-th application event that the computing application 104 exhibited in response to or otherwise during the functional test 206.

In various aspects, each of the set of application events 302 can be any suitable HTML DOM event pertaining to any suitable data object. As a non-limiting example, an application event can be any suitable mouse event, such as an OnClick event associated with a given data object identifier, an OnDblClick event associated with a given data object identifier, an OnMouseDown event associated with a given data object identifier, an OnMouseUp event associated with a given data object identifier, an OnMouseOver event associated with a given data object identifier, an OnMouseMove event associated with a given data object identifier, an OnMouseOut event associated with a given data object identifier, an OnDragStart event associated with a given data object identifier, an OnDrag event associated with a given data object identifier, an OnDrag Enter event associated with a given data object identifier, an OnDragLeave event associated with a given data object identifier, an OnDrop event associated with a given data object identifier, or an OnDragEnd event associated with a given data object identifier. As another non-limiting example, an application event can be any suitable keyboard event, such as an OnKeyDown event associated with a given data object identifier, an OnKeyPress event associated with a given data object identifier, or an OnKeyUp event associated with a given data object identifier. As still another non-limiting example, an application event can be any suitable HTML frame event, such as an OnLoad event associated with a given data object identifier, an On Unload event associated with a given data object identifier, an OnAbort event associated with a given data object identifier, an OnError event associated with a given data object identifier, an OnResize event associated with a given data object identifier, or an OnScroll event associated with a given data object identifier. As yet another non-limiting example, an application event can be any suitable HTML form event, such as an OnSelect event associated with a given data object identifier, an OnChange event associated with a given data object identifier, an OnSubmit event associated with a given data object identifier, an OnReset event associated with a given data object identifier, an OnFocus event associated with a given data object identifier, or an OnBlur event associated with a given data object identifier.

In various aspects, as shown, the event-trace stream 116 can comprise a set of execution location traces 304. In various instances, the set of execution location traces 304 can respectively correspond (e.g., in one-to-one fashion) to the set of application events 302. Accordingly, since the set of application events 302 can include n events, the set of execution location traces 304 can likewise include n traces: an execution location trace 304(1) to an execution location trace 304(n). In various cases, each of the set of execution location traces 304 can indicate or convey which particular lines of source code of the computing application 104 were executed for or otherwise during a respectively corresponding one of the set of application events 302, as recorded or captured by the execution tracers of the CI/CD pipeline 204. For example, the execution location trace 304(1) can correspond to the application event 302(1). Accordingly, the execution location trace 304(1) can specify, indicate, represent, or otherwise convey which specific portions or lines of code of the computing application 104 were executed for or during the application event 302(1). As another example, the execution location trace 304(n) can correspond to the application event 302(n). Accordingly, the execution location trace 304(n) can specify, indicate, represent, or otherwise convey which specific portions or lines of code of the computing application 104 were executed for or during the application event 302(n).

Accordingly, as shown, the event-trace stream 116 can be considered as representing the behavior which the computing application 104 exhibits in response to the functional test 206. Note that an application event might or might not be manifested in a visually-rendered graphical user-interface of the computing application 104. Accordingly, the event-trace stream 116 can be considered as holistically indicating the behavior of the computing application 104 (e.g., both visually-manifested behavior and non-visually-manifested behavior).

FIG. 4 illustrates an example, non-limiting block diagram 400 showing how the event-trace stream 118 of the modified computing application 106 can be generated in accordance with various examples described herein.

In various aspects, as shown, the test component 202 can execute the CI/CD pipeline 204 on the modified computing application 106. In particular, the CI/CD pipeline 204 can subject or expose the modified computing application 106 to the functional test 206 (e.g., to the same functional test to which the computing application 104 is exposed). Indeed, just as above, any suitable code compilers of the CI/CD pipeline 204 can compile the modified computing application 106 (e.g., can compile source code of the modified computing application 106). Based on such compilation, in various cases, any suitable code executors of the CI/CD pipeline 204 can execute the modified computing application 106. During runtime of the modified computing application 106, any suitable code executors of the CI/CD pipeline 204 can feed to the modified computing application 106 any suitable controlled inputs as specified by the functional test 206. In various aspects, as the modified computing application 106 is undergoing the functional test 206, any suitable event listeners of the CI/CD pipeline 204 can monitor the modified computing application 106, so as to record, log, capture, or otherwise detect any application events exhibited by the modified computing application 106 in response to the functional test 206. Furthermore, in various instances, any suitable execution tracers of the CI/CD pipeline 204 can monitor the modified computing application 106, so as to record, log, capture, or otherwise identify an execution location trace for each application event exhibited by the modified computing application 106 in response to the functional test 206. In various cases, such monitoring by the event listeners or execution tracers of the CI/CD pipeline 204 can yield the event-trace stream 118.

In various aspects, as shown, the event-trace stream 118 can comprise a set of application events 402. In various instances, the set of application events 402 can include m events for any suitable positive integer m: an application event 402(1) to an application event 402(m). In various cases, the set of application events 402 can be considered as indicating, in chronological order, the application events exhibited by the modified computing application 106 and recorded by the event listeners of the CI/CD pipeline 204 (e.g., can be considered as indicating the application events which the modified computing application 106 exhibits in response to the functional test 206). For example, the application event 402(1) can be considered as a first application event that the modified computing application 106 exhibited in response to or otherwise during the functional test 206, and the application event 402(m) can be considered as an m-th application event that the modified computing application 106 exhibited in response to or otherwise during the functional test 206. In various aspects, and just as above, each of the set of application events 402 can be any suitable HTML DOM event (e.g., a mouse event, a keyboard event, an HTML frame event, an HTML form event).

In various aspects, as shown, the event-trace stream 118 can comprise a set of execution location traces 404. In various instances, the set of execution location traces 404 can respectively correspond (e.g., in one-to-one fashion) to the set of application events 402. Accordingly, since the set of application events 402 can include m events, the set of execution location traces 404 can likewise include m traces: an execution location trace 404(1) to an execution location trace 404(m). In various cases, each of the set of execution location traces 404 can indicate or convey which particular lines of source code of the modified computing application 106 were executed for or otherwise during a respectively corresponding one of the set of application events 402, as recorded or captured by the execution tracers of the CI/CD pipeline 204. For example, the execution location trace 404(1) can correspond to the application event 402(1). Accordingly, the execution location trace 404(1) can specify, indicate, represent, or otherwise convey which specific portions or lines of code of the modified computing application 106 were executed for or during the application event 402(1). As another example, the execution location trace 404(m) can correspond to the application event 402(m). Accordingly, the execution location trace 404(m) can specify, indicate, represent, or otherwise convey which specific portions or lines of code of the modified computing application 106 were executed for or during the application event 402(m).

Accordingly, as shown, the event-trace stream 118 can be considered as representing the behavior which the modified computing application 106 exhibits in response to the functional test 206. Note that, as mentioned above, an application event might or might not be manifested in a visually-rendered graphical user-interface of the modified computing application 106. Accordingly, the event-trace stream 118 can be considered as holistically indicating the behavior of the modified computing application 106 (e.g., both visually-manifested behavior and non-visually-manifested behavior).

Referring back to FIG. 2, as shown, the difference component 114 can, in various aspects, electronically store, electronically maintain, electronically control, or otherwise electronically access a sequential pattern miner 208. In various instances, the sequential pattern miner 208 can be any suitable combination of computer-executable hardware or machine-readable instructions that, upon execution, can perform any suitable sequential pattern mining technique on inputted sequences. As a non-limiting example, the sequential pattern miner 208 can perform a GSP algorithm on inputted sequences. As another non-limiting example, the sequential pattern miner 208 can perform a SPADE algorithm on inputted sequences. As still another non-limiting example, the sequential pattern miner 208 can perform a FreeSpan algorithm on inputted sequences. As yet another non-limiting example, the sequential pattern miner 208 can perform a PrefixSpan algorithm on inputted sequences. As even another non-limiting example, the sequential pattern miner 208 can perform an MAPres algorithm on inputted sequences. As yet another non-limiting example, the sequential pattern miner 208 can perform a Seq2Pat algorithm on inputted sequences. As still another non-limiting example, the sequential pattern miner 208 can perform on inputted sequences any suitable pairwise sequence alignment technique, any suitable multiple sequence alignment technique, or any suitable hierarchical sequence alignment technique, such as by leveraging the Needleman-Wunsch algorithm or the Smith-Waterman algorithm (e.g., although such techniques are often applied to sequences whose ordered items represent genetic information, the present inventors realized that such techniques can be equally applicable to sequences whose ordered items represent application events tagged with execution location traces). In various cases, the sequential pattern miner 208 can perform any suitable combination of any of the aforementioned non-limiting examples of sequential pattern mining techniques.

In any case, the sequential pattern miner 208 can apply any suitable sequential pattern mining techniques to inputted sequences, so as to identify or otherwise detect differences (e.g., discrepancies, mismatches) between such inputted sequences.

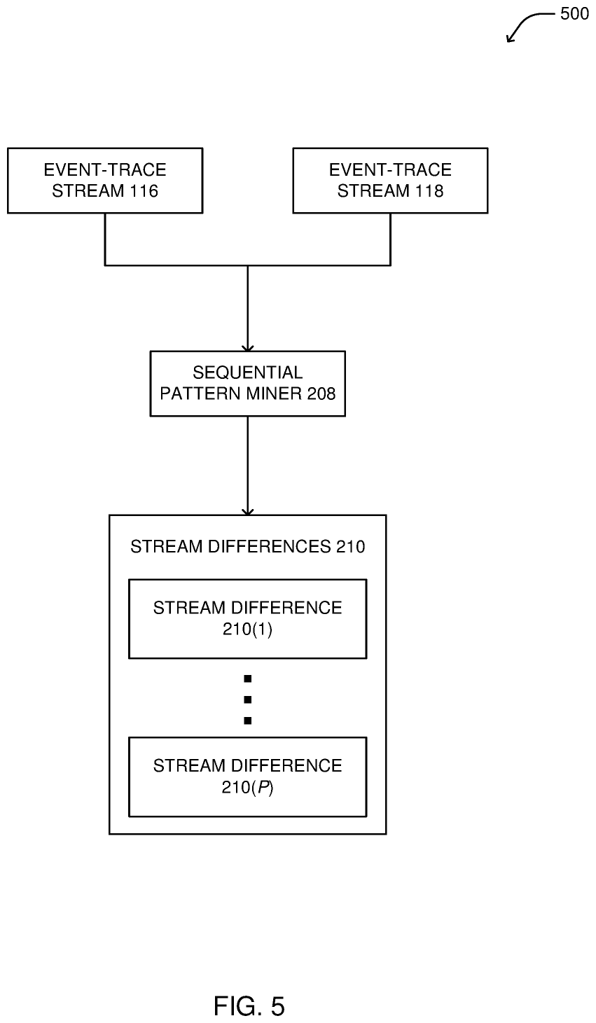

Accordingly, because the event-trace stream 116 and the event-trace stream 118 can be considered as sequences, the difference component 114 can feed both the event-trace stream 116 and the event-trace stream 118 to the sequential pattern miner 208, and the sequential pattern miner 208 can output a set of stream differences 210. Various aspects are described with respect to FIG. 5.

FIG. 5 illustrates an example, non-limiting block diagram 500 showing how the set of stream differences 210 can be detected in accordance with various examples described herein.

As shown, the sequential pattern miner 208 can, in various aspects, receive as input both the event-trace stream 116 and the event-trace stream 118, and can produce as output the set of stream differences 210. In various instances, the set of stream differences 210 can include p differences for any suitable positive integer p: a stream difference 210(1) to a stream difference 210(p). In various cases, a stream difference can be any suitable electronic data that indicates, conveys, calls-out, highlights, or otherwise represents a mismatch or discrepancy between the event-trace stream 116 and the event-trace stream 118.

In various aspects, a mismatch or discrepancy can occur when an application event at a given sequential position in the event-trace stream 116 does not match (e.g., is not the same as) an application event at that same given sequential position in the event-trace stream 118. As a non-limiting example, suppose that an x-th application event, for any suitable positive integer x, in the event-trace stream 116 is an OnFocus event corresponding to a particular rendered text field. If the x-th application event in the event-trace stream 118 is not an OnFocus event corresponding to such particular rendered text field, this can be considered as a mismatch or discrepancy between the event-trace stream 116 and the event-trace stream 118. In various cases, a stream difference in the set of stream differences 210 can indicate, convey, or otherwise call-out such mismatch/discrepancy.

In various instances, a mismatch or discrepancy can occur when properties or characteristics of an application event at a given sequential position in the event-trace stream 116 do not match (e.g., are not the same as) those of an application event at that same given sequential position in the event-trace stream 118. As a non-limiting example, suppose that a y-th application event, for any suitable positive integer y, in the event-trace stream 116 is an OnLoad event corresponding to a particular electronic file. If the y-th application event in the event-trace stream 118 is an OnLoad event for a different electronic file (e.g., having a different file identifier, having a different file size, having different file content), then this can be considered as a mismatch or discrepancy between the event-trace stream 116 and the event-trace stream 118, and a stream difference in the set of stream differences 210 can indicate, convey, or otherwise call-out such mismatch/discrepancy.

In various aspects, a mismatch or discrepancy can occur when an execution location trace of an application event at a given sequential position in the event-trace stream 116 does not match (e.g., is not the same as) an execution location trace of an application event at that same given sequential position in the event-trace stream 118. As a non-limiting example, suppose that a z-th application event in the event-trace stream 116 is an OnUnload event corresponding to a particular electronic document, where the execution location trace of such OnUnload event indicates that line a to line b of the source code of the computing application 104 were executed during such OnUnload event, for any suitable positive integers z and a<b. Furthermore, suppose that the z-th application event in the event-trace stream 118 is also an OnUnload event for that same particular electronic document. If the execution location trace of that OnUnload event in the event-trace stream 118 does not indicate the line a to the line b, then this can be considered as a mismatch or discrepancy between the event-trace stream 116 and the event-trace stream 118, and a stream difference in the set of stream differences 210 can indicate, convey, or otherwise call-out such mismatch/discrepancy.

In any case, the set of stream differences 210 can be considered as indicating or representing how the computing application 104 responded differently to the functional test 206 as compared to the modified computing application 106. Accordingly, in various aspects, the set of stream differences 210 can be considered as a result of performing a pull request review on the computing application 104 and on the modified computing application 106.

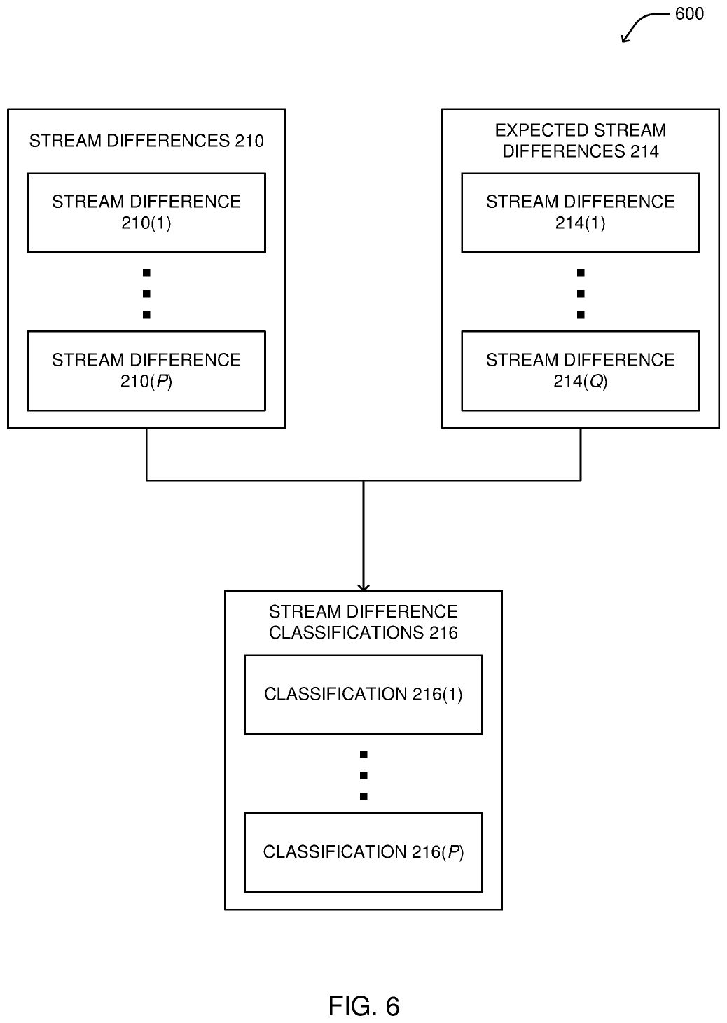

Referring back to FIG. 2, the code review system 102 can comprise a classification component 212. In various aspects, the classification component 212 can electronically store, electronically maintain, electronically retrieve, or otherwise electronically access a set of expected stream differences 214. Moreover, in various instances, the classification component 212 can electronically classify each of the set of stream differences 210 as either expected or unexpected based on the set of expected stream differences 214, thereby yielding a set of stream difference classifications 216. Various aspects are described with respect to FIG. 6.

FIG. 6 illustrates an example, non-limiting block diagram 600 showing how the set of stream difference classifications 216 can be generated in accordance with various examples described herein.

In various aspects, as shown, the set of expected stream differences 214 can include q stream differences for any suitable positive integer q: a stream difference 214(1) to a stream difference 214(q). In various instances, the set of expected stream differences 214 can be generated manually by technicians that oversee the computing application 104 or that oversee the modified computing application 106. In various other instances, the set of expected stream differences 214 can be generated based on historical stream differences observed when prior computing applications were modified and functionally tested. In any case, the set of expected stream differences 214 can be considered as conveying, indicating, or otherwise representing behavioral differences that were expected, intended, or wanted to occur between the computing application 104 and the modified computing application 106. In other words, a technician that edited the computing application 104 so as to create the modified computing application 106 can have wanted or intended for certain portions of the modified computing application 106 to behave differently than corresponding portions of the computing application 104, and the set of expected stream differences 214 can convey or represent such intended or wanted behavioral differences. In still other words, the set of stream differences 210 can indicate/represent how the modified computing application 106 actually behaves differently than the computing application 104, whereas the set of expected stream differences 214 can be ground-truths indicating/representing how the modified computing application 106 was supposed/intended to behave differently than the computing application 104.

In various aspects, the classification component 212 can electronically compare each given stream difference in the set of stream differences 210 to the set of expected stream differences 214, so as to classify such given stream difference as expected or unexpected. This can result in a set of stream difference classifications 216.

In various instances, the set of stream difference classifications 216 can respectively correspond (e.g., in one-to-one fashion) to the set of stream differences 210. Accordingly, since the set of stream differences 210 can have p differences, the set of stream difference classifications 216 can have p classifications: a classification 216(1) to a classification 216(p). In various cases, each of the set of stream difference classifications 216 can be any suitable classification label that indicates whether a respectively corresponding one of the set of stream differences 210 is an expected difference or an unexpected difference. In various aspects, the classification component 212 can generate the set of stream difference classifications 216 by comparing the set of stream differences 210 to the set of expected stream differences 214.

As a non-limiting example, the classification component 212 can search the set of expected stream differences 214 for the stream difference 210(1). If the stream difference 210(1) is present within the set of expected stream differences 214, then the classification 216(1) can be any suitable label indicating that the stream difference 210(1) is expected. On the other hand, if the stream difference 210(1) is not present within the set of expected stream differences 214, then the classification 216(1) can be any suitable label indicating that the stream difference 210(1) is unexpected.

As another non-limiting example, the classification component 212 can search the set of expected stream differences 214 for the stream difference 210(p). If the stream difference 210(p) is present within the set of expected stream differences 214, then the classification 216(p) can be any suitable label indicating that the stream difference 210(p) is expected. On the other hand, if the stream difference 210(p) is not present within the set of expected stream differences 214, then the classification 216(p) can be any suitable label indicating that the stream difference 210(p) is unexpected.

In various aspects, the set of stream difference classifications 216 can be considered as an addition result of performing a pull request review on the computing application 104 and on the modified computing application 106.

Referring back to FIG. 2, the code review system 102 can comprise a result component 218. In various aspects, the result component 218 can initiate any suitable electronic actions based on the set of stream differences 210 or based on the set of stream difference classifications 216.

As a non-limiting example, the result component 218 can electronically transmit the set of stream differences 210, the set of stream difference classifications 216, or any suitable portions thereof to any suitable computing devices (not shown).

As another non-limiting example, the result component 218 can electronically render the set of stream differences 210, the set of stream difference classifications 216, or any suitable portions thereof on any suitable electronic display (not shown).

As yet another non-limiting example, the result component 218 can generate, transmit, or render any suitable electronic alert pertaining to deployment of the modified computing application 106, based on the set of stream differences 210 or based on the set of stream difference classifications 216. For instance, if any of the set of stream differences 210 is unexpected (e.g., as indicated by the set of stream difference classifications 216), then the result component 218 can generate, transmit, or render an electronic alert that recommends against deployment of the modified computing application 106. In contrast, if all of the set of stream differences 210 are expected (e.g., as indicated by the set of stream difference classifications 216), then the result component 218 can generate, transmit, or render an electronic alert that recommends deploying the modified computing application 106. In some cases, if all of the set of stream differences 210 are expected (e.g., as indicated by the set of stream difference classifications 216), then the result component 218 can deploy the modified computing application 106. In still other cases, if any of the set of expected stream differences 214 is not present within the set of stream differences 210, then the result component 218 can generate, transmit, or render an electronic alert that recommends against deployment of the modified computing application 106.

Although the Figures illustrates a single instance of the functional test 206, this is a mere non-limiting example for ease of illustration and explanation. In various aspects, the test component 202 can store, maintain, retrieve, or otherwise access any suitable number of unique functional tests. In such cases, such unique functional tests can be clustered or grouped according to any suitable criteria (e.g., can be grouped according to application-specific context or operational environment, can be grouped according to type of simulated user-interaction, can be grouped according to level of importance or criticality). Moreover, in such cases, the CI/CD pipeline 204 can subject both the computing application 104 and the modified computing application 106 to each of such multiple functional tests, thereby yielding a pair of event-trace streams for each of such multiple functional tests. In this way, multiple event-trace streams of the computing application 104 can be respectively compared, via sequential pattern mining, to multiple event-trace streams of the modified computing application 106.

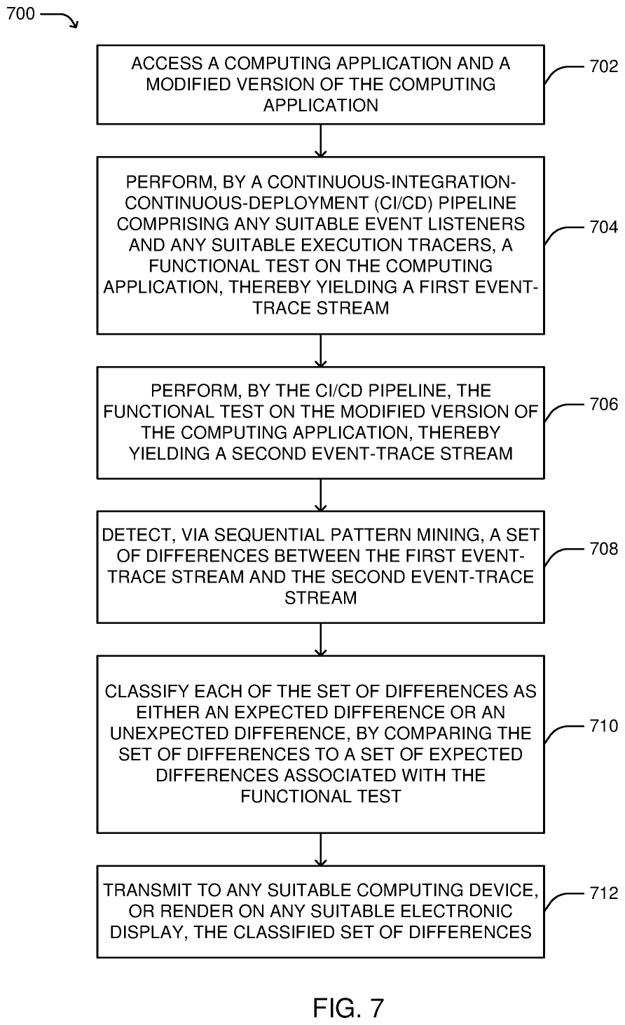

FIG. 7 illustrates a flow diagram of an example, non-limiting computer-implemented method 700 that can facilitate pull request reviews based on event-trace streams in accordance with various examples described herein. In various cases, the code review system 102 can facilitate the computer-implemented method 700.

In various aspects, act 702 can include accessing, by a device (e.g., via 112) operatively coupled to a processor (e.g., 108), a computing application (e.g., 104) and a modified version of the computing application (e.g., 106).

In various instances, act 704 can include performing, by the device (e.g., via 202) and via a continuous-integration-continuous-deployment pipeline (e.g., 204) comprising any suitable event listeners and any suitable execution tracers, a functional test (e.g., 206) on the computing application. This can yield a first event-trace stream (e.g., 116).

In various cases, act 706 can include performing, by the device (e.g., via 202) and via the continuous-integration-continuous-deployment pipeline, the functional test on the modified version of the computing application. This can yield a second event-trace stream (e.g., 118).

In various aspects, act 708 can include detecting, by the device (e.g., via 114) and via sequential pattern mining (e.g., 208), a set of differences (e.g., 210) between the first event-trace stream and the second event-trace stream.

In various instances, act 710 can include classifying, by the device (e.g., via 212), each of the set of differences as either an expected difference or an unexpected difference. In various cases, this can be facilitated by comparing the set of differences to a set of expected differences (e.g., 214) associated with the functional test or with the modified version of the computing application.

In various cases, act 712 can include transmitting, by the device (e.g., via 218) and to any suitable computing device, or rending, by the device (e.g., via 218) and on any suitable electronic display, the classified set of differences.

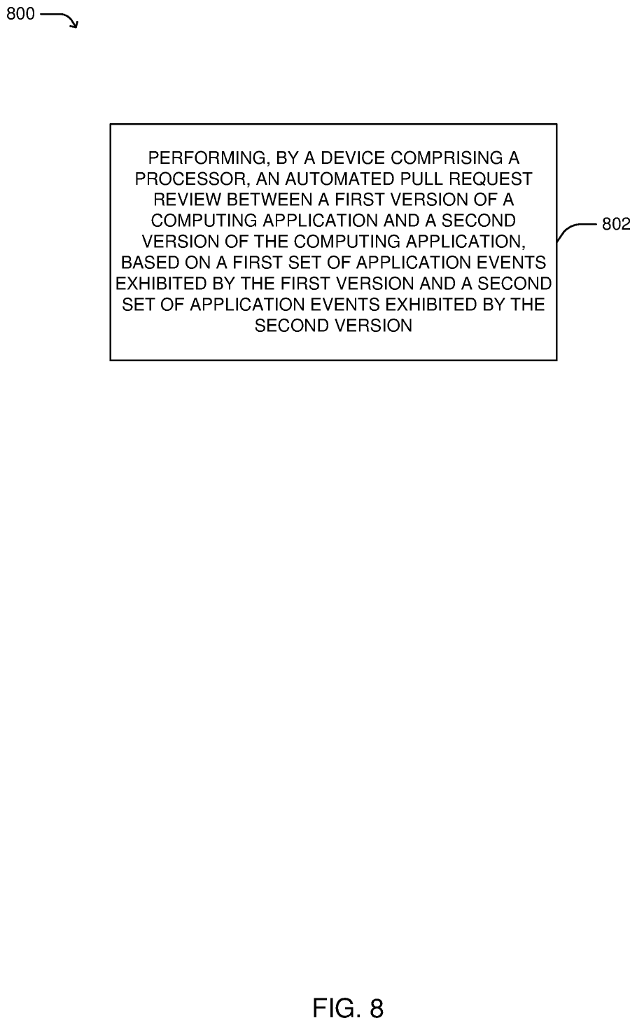

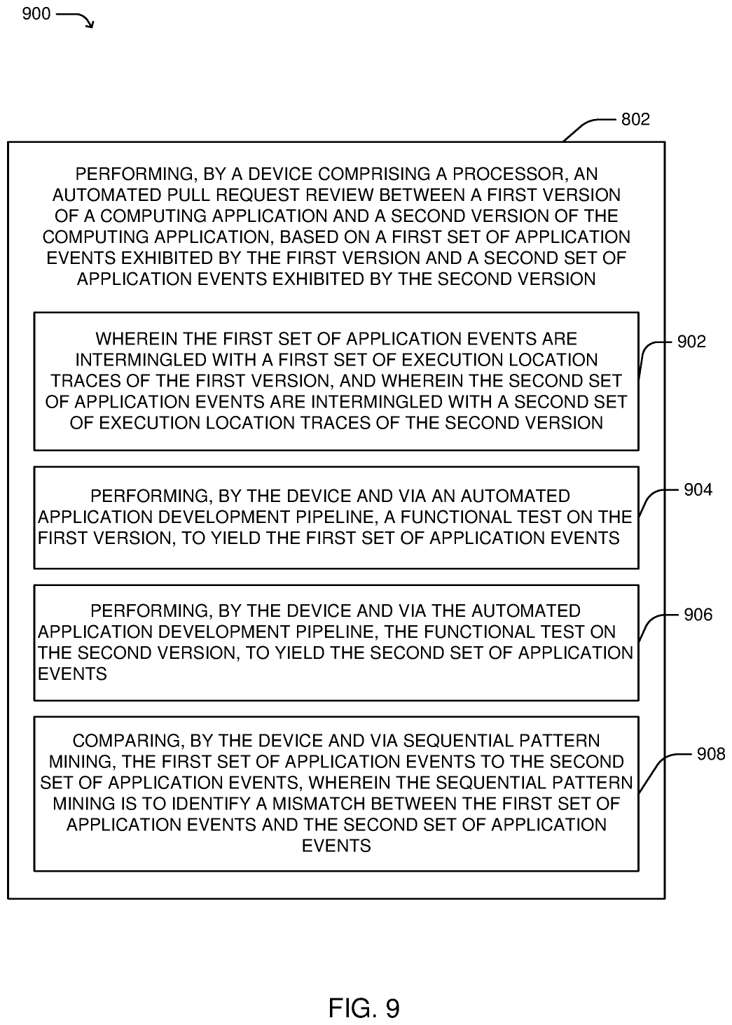

FIGS. 8-9 illustrate flow diagrams of example, non-limiting computer-implemented methods 800-900 that can facilitate pull request reviews based on event-trace streams in accordance with various examples described herein. In various cases, the code review system 102 can facilitate the computer-implemented method 800.

In various aspects, act 802 can include performing, by a device (e.g., via 114) comprising a processor (e.g., 108), an automated pull request review between a first version of a computing application (e.g., 104) and a second version of the computing application (e.g., 106), based on a first set of application events (e.g., 302) exhibited by the first version and a second set of application events (e.g., 402) exhibited by the second version.

Now, consider the computer-implemented method 900. In various aspects, as shown, the computer-implemented method 900 can include the act 802, as described above. As indicated by a numeral 902, the act 802 can include the following: the first set of application events can be intermingled with a first set of execution location traces (e.g., 304) of the first version of the computing application; and the second set of application events can be intermingled with a second set of execution location traces (e.g., 404) of the second version of the computing application.

In various cases, the act 802 can comprise an act 904, which can include performing, by the device (e.g., via 202) and via an automated application development pipeline (e.g., 204), a functional test (e.g., 206) on the first version of the computing application, to yield the first set of application events.

In various aspects, the act 802 can comprise an act 906, which can include performing, by the device (e.g., via 202) and via the automated application development pipeline, the functional test on the second version of the computing application, to yield the second set of application events.

In various instances, the act 802 can comprise an act 908, which can include comparing, by the device (e.g., via 114) and via sequential pattern mining (e.g., 208), the first set of application events to the second set of application events. In various cases, the sequential pattern mining can identify a mismatch between the first set of application events and the second set of application events.

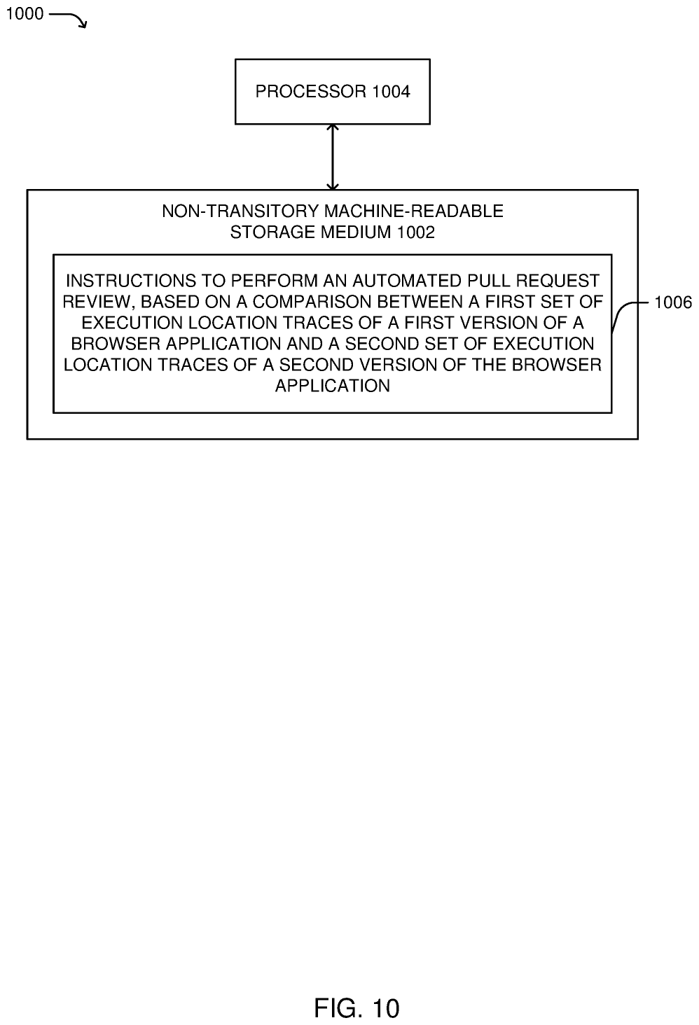

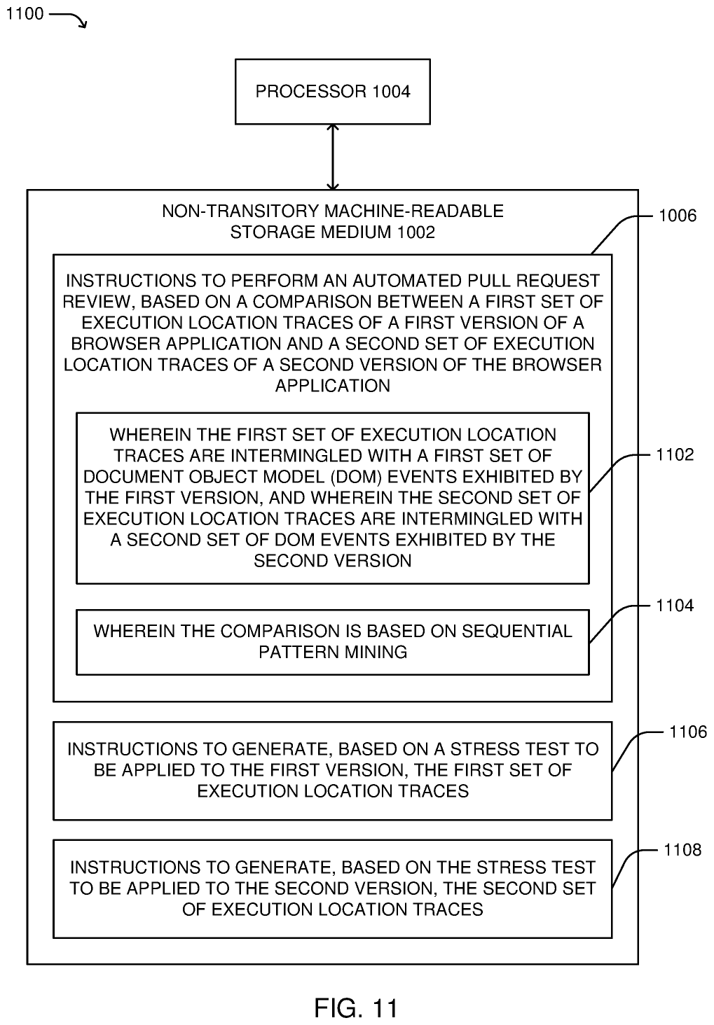

FIGS. 10-11 illustrate block diagrams 1000-1100 of example, non-limiting non-transitory machine-readable storage media that can facilitate pull request reviews based on event-trace streams in accordance with various examples described herein.

First, consider the non-limiting block diagram 1000 of FIG. 10. As shown, there can be a non-transitory machine-readable storage medium 1002. In various aspects, the non-transitory machine-readable storage medium 1002 can include a single form of computer memory or multiple forms of computer memory. In various instances, the non-transitory machine-readable storage medium 1002 can be an electronic, magnetic, optical, or other physical storage device that stores executable non-transitory machine-readable storage media instructions. Thus, the non-transitory machine-readable storage medium 1002 may be, for example, RAM, an electrically-erasable programmable read-only memory (“EEPROM”), a storage drive, an optical disc, or the like. In various cases, the non-transitory machine-readable storage medium 1002 can be electronically integrated, via any suitable wired or wireless electronic connection, with a processor 1004. In various aspects, the non-transitory machine-readable storage medium 1002 can electronically store or maintain any suitable machine-readable instructions, or the processor 1004 can electronically execute or perform such machine-readable instructions.

In various aspects, the non-transitory machine-readable storage medium 1002 can comprise instructions 1006. In various instances, the instructions 1006 can be instructions to perform an automated pull request review, based on a comparison between a first set of execution location traces (e.g., 304) of a first version of a browser application (e.g., 104) and a second set of execution location traces (e.g., 404) of a second version of the browser application (e.g., 106).

Now, consider the non-limiting block diagram 1100 of FIG. 11. In various aspects, and as denoted by a numeral 1102, the instructions 1006 can be such that the first set of execution location traces can be intermingled with a first set of DOM events (e.g., 302) exhibited by the first version of the computing application, and such that the second set of execution location traces can be intermingled with a second set of DOM events (e.g., 402) exhibited by the second version of the computing application. Furthermore, as shown by a numeral 1104, the instructions 1006 can be such that the comparison can be based on sequential pattern mining (e.g., via 208).

In various instances, as shown, the non-transitory machine-readable storage medium 1002 can comprise instructions 1106. In various cases, the instructions 1106 can be instructions to generate, based on a stress test (e.g., 206) to be applied to the first version, the first set of execution location traces.

In various aspects, as shown, the non-transitory machine-readable storage medium 1002 can comprise instructions 1108. In various cases, the instructions 1108 can be instructions to generate, based on the stress test to be applied to the second version, the second set of execution location traces.

Accordingly, various examples described herein can be considered as a computerized tool that can perform automated pull request reviews based on event-trace streams. As described herein, such automated pull request reviews can capture or otherwise detect behavioral differences between two different versions of a computing application, even if such behavioral differences are not visually-manifested or otherwise do not affect visually-rendered graphical user-interfaces of the computing application. Such non-visually-manifested behavioral differences cannot be detected by automated pull request reviews that rely upon pixel-to-pixel visual comparisons. Accordingly, various examples described herein constitute useful and practical applications of computers.

The herein disclosure describes non-limiting examples. For ease of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

While various examples are described herein in the general context of non-transitory machine-readable storage media instructions that can run on computers, such examples can be implemented in combination with other program components or as a combination of hardware and non-transitory machine-readable storage media instructions. Generally, program components can include routines, programs, modules, data structures, or the like, that can perform particular tasks or that can implement particular abstract data types.

Various examples described herein can be practiced in distributed computing environments where any suitable tasks can be performed by remote processing devices linked through any suitable communications network. In a distributed computing environment, program components can be located in local or remote memory storage devices.

Various teachings described herein include mere non-limiting examples of apparatuses, computing devices, computer program products, or computer-implemented methods. It is, of course, not possible to describe every conceivable combination of components, products, devices, apparatuses, or computer-implemented methods for purposes of describing this disclosure. However, in view of the herein teachings, various further combinations or permutations of this disclosure are possible.

To the extent that the terms “includes,” “has,” “possesses,” and the like are used in the detailed description, claims, appendices, or drawings, such terms are intended to be inclusive in a manner similar to the term “comprising” as “comprising” is interpreted when employed as a transitional word in a claim. The descriptions of the various examples have been presented for purposes of illustration, and such descriptions are not intended to be exhaustive or limited to the examples disclosed. Many modifications or variations can be implemented without departing from the scope and spirit of the described examples.

As used herein, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used herein and annexed drawings should generally be construed to mean “one or more” unless specified otherwise or clear from context to be directed to a singular form. As used herein, the term “example” is utilized to mean serving as an example, instance, or illustration. For the avoidance of doubt, the subject matter disclosed herein is not limited by such examples.

What is claimed is:

1. A device, comprising:
a processor; and
a non-transitory machine-readable memory with machine-readable instructions stored thereon, the machine-readable instructions executable to cause the processor to:
perform an automated pull request review for a first version of a computing application and a second version of the computing application, based on a first event-trace stream associated with the first version and a second event-trace stream associated with the second version.

2. The device of claim 1, wherein the first event-trace stream comprises a first set of application events exhibited by the first version and intermingled with a first set of execution location traces of the first version, and wherein the second event-trace stream comprises a second set of application events exhibited by the second version and intermingled with a second set of execution location traces of the second version.

3. The device of claim 1, wherein the machine-readable instructions are executable to cause the processor to:
generate the first event-trace stream and the second event-trace stream, based on a functional test to be applied to the first version and to the second version via a continuous-integration-continuous-deployment pipeline.

4. The device of claim 1, wherein the processor is to perform the automated pull request review via a sequential pattern mining comparison between the first event-trace stream and the second event-trace stream.

5. The device of claim 4, wherein the sequential pattern mining comparison is to detect a difference between the first event-trace stream and the second event-trace stream.

6. The device of claim 5, wherein the difference is classified as an expected difference or an unexpected difference.

7. A method, comprising:
performing, by a device comprising a processor, an automated pull request review between a first version of a computing application and a second version of the computing application, based on a first set of application events exhibited by the first version and a second set of application events exhibited by the second version.

8. The method of claim 7, wherein the first set of application events are intermingled with a first set of execution location traces of the first version, and wherein the second set of application events are intermingled with a second set of execution location traces of the second version.

9. The method of claim 7, comprising:
performing, by the device and via an automated application development pipeline, a functional test on the first version, to yield the first set of application events; and
performing, by the device and via the automated application development pipeline, the functional test on the second version, to yield the second set of application events.

10. The method of claim 7, wherein the performing the automated pull request review comprises comparing, by the device and via sequential pattern mining, the first set of application events to the second set of application events.

11. The method of claim 10, wherein the sequential pattern mining is to identify a mismatch between the first set of application events and the second set of application events.

12. A non-transitory machine-readable storage medium encoded with instructions executable by a processor, the non-transitory machine-readable storage medium comprising:
instructions to perform an automated pull request review, based on a comparison between a first set of execution location traces of a first version of a browser application and a second set of execution location traces of a second version of the browser application.

13. The non-transitory machine-readable storage medium of claim 12, wherein the first set of execution location traces are intermingled with a first set of document object model (DOM) events exhibited by the first version, and wherein the second set of execution location traces are intermingled with a second set of DOM events exhibited by the second version.

14. The non-transitory machine-readable storage medium of claim 12, comprising:
instructions to generate, based on a stress test to be applied to the first version, the first set of execution location traces; and
instructions to generate, based on the stress test to be applied to the second version, the second set of execution location traces.

15. The non-transitory machine-readable storage medium of claim 12, wherein the comparison is based on sequential pattern mining.
